(19) United States
(12) Patent Application Publication
(10) Pub. No.: US 2020/0288548 A1
(43) Pub. Date: Sep. 10, 2020

(54) LIGHTS COMPOSED OF NARROW BAND LIGHT EMITTING DIODES WITH VARIABLE INTENSITY

(71) Applicants: Anthony Catalano, (US); Alliance for Sustainable Energy, LLC, Golden, CO (US)

(72) Inventors: Paul Francois NDIONE, Lakewood, CO (US); Kirstin ALBERI, Denver, CO (US); Anthony CATALANO, Boulder, CO (US)

(21) Appl. No.: 16/801,888

(22) Filed: Feb. 26, 2020

Related U.S. Application Data
(60) Provisional application No. 62/815,016, filed on Mar. 7, 2019.

(51) Int. Cl. H05B 45/10; H05B 47/16; F21V 13/08

(52) U.S. Cl. CPC H05B 45/10; F21Y 2115/10; F21V 13/08; H05B 47/16

(57) ABSTRACT

The present disclosure relates to a device that includes a blue-emitting light emitting diode (LED) capable of emitting blue light at a first intensity and a non-blue-emitting LED capable of emitting light having a color other than blue, at a second intensity, where the first intensity is variable.

### CROSS-REFERENCE TO RELATED APPLICATIONS

This application claims priority from U.S. Provisional Patent Application No. 62/815,016 filed Mar. 7, 2019, the disclosure of which is incorporated herein by reference in its entirety.

### CONTRACTUAL ORIGIN

This invention was made with government support under Contract No. DE-AC36-08G028308 awarded by the Department of Energy. The government has certain rights in the invention.

### SUMMARY

An aspect of the present disclosure is a device that includes a blue-emitting light emitting diode (LED) capable of emitting blue light at a first intensity and a non-blue-emitting LED capable of emitting light having a color other than blue, at a second intensity, where the first intensity is variable. In some embodiments of the present disclosure, the color other than blue may include a light in the visible spectrum. In some embodiments of the present disclosure, the device may further include an element capable of varying the first intensity. In some embodiments of the present disclosure, the element may be an electronic driver. In some embodiments of the present disclosure, the device may further include electronics configured to determine when the first intensity needs to be varied. In some embodiments of the present disclosure, the electronics may include at least one of software and/or hardware.

In some embodiments of the present disclosure, the hardware may include a timer, the first intensity may have a low intensity value and a high intensity value determined by the software, and the software and the timer may be configured to communicate when the electronic driver adjusts a current to the blue-emitting LED to attain both the low intensity value and the high intensity value. In some embodiments of the present disclosure, the low intensity value may be determined by a tolerance level of local wildlife. In some embodiments of the present disclosure, the high intensity value may be determined by a value set by local rules and regulations. In some embodiments of the present disclosure, the device may include two or more blue-emitting LEDs. In some embodiments of the present disclosure, the color other than blue may include least one of red, amber, yellow, and/or green.

In some embodiments of the present disclosure, the timer may be a digital clock. In some embodiments of the present disclosure, the second intensity may be variable. In some embodiments of the present disclosure, the device may further include a first optical component, where the first optical component varies at least one of the first intensity and/or a wavelength of the blue-emitting LED. In some embodiments of the present disclosure, the first optical component may include an optical filter. In some embodiments of the present disclosure, the optical filter may include at least one of a colored glass filter, a bandpass filter, a laser line filter, an edge pass filter, a notch filter, and/or a dichroic color filter. In some embodiments of the present disclosure, the device may further include a second optical component, where the second optical component mixes the blue light with the non-blue light. In some embodiments of the present disclosure, the second optical component may include a textured reflector capable of scattering the blue light and the non-blue light. In some embodiments of the present disclosure, the blue light and the non-blue light mix to create light having a color temperature between about 2000K and about 6000K.

An aspect of the present disclosure is a method that includes mixing a blue light with a second light that is in the visible spectrum and not blue and varying an intensity of the blue light, where the mixing and the varying result in a light having a property that includes at least one of a color temperature, a color-rendering index, a wavelength distribution, and/or a total intensity, where the property meets at least one of a tolerance level of local wildlife and/or a value set by a local regulation.

### BACKGROUND

Communities around the country are switching out their old roadside lighting for energy-efficient light emitting diode (LED) lights, but some of those new lights might create unintended consequences. According to the American Medical Association, they could be putting both people and wildlife at risk. Studies have shown that LED lights that emit a large portion of light at blue wavelengths can create a disorienting glare for drivers. The bright lights can also disrupt natural circadian rhythms, during which, according to one report, “melatonin blood concentrations rise, body temperature drops, sleepiness grows, and hunger abates, along with several other responses.”

The lights also have an adverse effect on nocturnal wildlife. Scientists have found that migrating birds are attracted to unnatural lighting, which often results in injuries or death when they collide with reflections on buildings or other structures. High-intensity light pollution has also been linked to low survival rates for hatchling sea turtles and even to inhibited migration rates for salmon and other fish. Additionally, brighter light emitted from outdoor lighting at all visible wavelengths contributes to sky glow, preventing us from seeing and detecting star light from the night sky. Thus, there remains a need for outdoor lighting systems that provide the benefits of high efficiency LED lights while avoiding the potential negative effects on both humans and wildlife.

### BRIEF DESCRIPTION OF THE DRAWINGS

Some embodiments are illustrated in the referenced FIGURE. It is intended that the embodiments and FIGURE disclosed herein are to be considered illustrative rather than limiting.

FIG. 1 illustrates a light-emitting device, according to some embodiments of the present disclosure.

### REFERENCE NUMBERS

100 . . . light-emitting device
110 . . . blue-emitting light emitting diode (LED)
120 . . . non-blue-emitting LED
130 . . . intensity varying element
140 . . . electronics

### DETAILED DESCRIPTION

The present disclosure may address one or more of the problems and deficiencies of the prior art discussed above. However, it is contemplated that some embodiments as disclosed herein may prove useful in addressing other problems and deficiencies in a number of technical areas. Therefore, the embodiments described herein should not necessarily be construed as limited to addressing any of the particular problems or deficiencies discussed herein.

References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

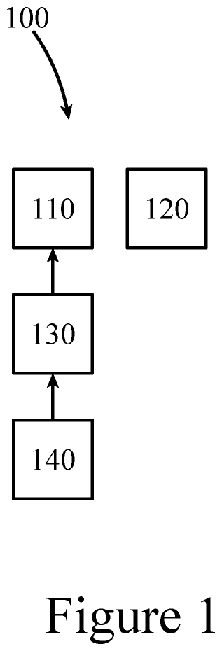

The present disclosure relates to light-emitting devices configured for outdoor use, for example spot lights, street lights and decorative lighting, that are both energy efficient and minimally-disruptive to local wildlife and human inhabitants. Referring to FIG. 1, some embodiments of the present disclosure, such a light-emitting device 100 may include a narrow band blue-emitting LED 110 capable of emitting blue light at a first intensity. So, as defined herein, a blue LED emits blue light, a green LED emits green light, etc. The ranges of peak wavelengths that this blue-emitting LED could operate in may include a wavelength between about 420 nm and about 500 nm, or between about 440 nm and about 460 nm, with a full width half maximum (FWHM) wavelength distribution of less than 30 nm. The light-emitting device 100 may also include at least one non-blue emitting LED 120, capable of emitting a narrow band of visible light that is in at least one of the wavelength ranges associated with red, amber, and/or green. The wavelength ranges and FWHM values for these colors are listed in Table 1. The intensity of the blue-emitting LED 110 may be varied relative to that of the non-blue emitting LED depending on the local requirements as defined by at least one of the tolerance levels of the local wildlife and/or the local municipal, county, state, and/or federal laws, rules, and/or regulations. One measure of relative intensities is a combination of the color-rendering index, Rₐ, specified by the International Commission on Illumination, and the special color-rendering index for red wavelengths, R₉. For high blue light intensities, values of Rₐ>80 and R₉>70 may be acceptable. For low blue light intensities, values of Rₐ<25 and R₉>70 may be acceptable.

Thus, the operating of a light-emitting device 100, according to some embodiments of the present disclosure, may be designed to be “optimized” for human use during high traffic periods and also “optimized” for wildlife during low traffic periods. For example, the intensity of the blue-emitting LED 110 may be relatively high during the early evening hours, for example between 5 PM and 9 PM, but may then be significantly reduced and/or completely reduced to zero after 9 PM. The intensity may then be increased for another early morning period of time, for example, to accommodate early morning “rush hour” traffic during the winter months. The total number of blue and non-blue LEDs in each fixture may be selected for the desired total light output of the fixture. For example, the total intensity output by a light-emitting device as described herein may be between about 10 lumens and about 40,000 lumens. In this case, the intensity of the light source may be controlled individually, or by wavelengths groups by controlling each LED and/or by controlling a subgroup of LEDs of the same wavelengths and/or a subgroup of LEDs of different wavelengths.

TABLE 1
Wavelength Ranges and FWHM Values

| | Broad Range of Peak | Narrow Range of Peak | FWHM |
|---|---|---|---|
| Color | Wavelengths (nm) | Wavelengths (nm) | (nm) |
| Blue | 420-500 | 440-460 | ≤30 |
| Green | 500-560 | 520-540 | ≤30 |
| Amber | 560-600 | 570-590 | ≤30 |
| Red | 600-650 | 610-630 | ≤30 |

In some embodiments of the present disclosure, the intensity of the light emitted by a blue-emitting LED 110 may be varied by varying the current provided to the blue-emitting LED 110 using an intensity varying element 130. An intensity varying element 130 may be an electronic driver and/or any other suitable electrical element. In some embodiments of the present disclosure, the light from the individual LEDs comprising the light-emitting device may be mixed by a series of optical components to produce a uniform light pattern.

Referring again to FIG. 1, in some embodiments of the present disclosure, a light-emitting device 100 may include electronics 140 for regulating and/or controlling the intensity of the blue-emitting LED 110. The light-emitting device 100 may also include a non-blue light-emitting LED 120 whose intensity may or may not also be controlled by the same and/or different electronics (not shown). Such electronics 140 may include any suitable hardware and/or software needed to define, among other things, at least one low intensity setting and/or at least one high intensity setting for the intensity of the light emitted by the blue-emitting LED 110 and/or the intensity setting of the non-blue light-emitting LED 120. In some embodiments of the present disclosure, hardware of the electronics 140 may include at least one of a timer and/or clock. In some embodiments of the present disclosure, software of the electronics 140 may include set points that define the at least one low intensity setting and/or at least one high intensity setting for the intensity of the light emitted by the blue-emitting LED 110 and/or for the intensity of the non-blue light-emitting LED 120. A user may program/enter the desired setpoints manually into software and/or they may be calculated by an algorithm using predefined parameters, for example, longitude and/or latitude of the position of the device, hours of daylight, seasonal wildlife data (e.g. migratory patterns, spawning patterns, night-time foraging patterns, etc.). In some embodiments of the present disclosure, the electronics 140 may send a signal to an intensity varying element 130 that, for example, controls the current and/or voltage supplied to the blue-emitting LED 110 and/or the non-blue light-emitting LED 120, changing at least one light intensity

In some embodiments, a sensor can be used to measure the relative output intensities of the LEDs to provide feedback to the control system and accurately control their light output intensities. At least one of a motion sensor and/or visual recognition device may be used, for example by linking these hardware to the software to automatically control the light spectrum output by the light emitting device in response to the motion of wildlife in the local area.

In some embodiments of the present disclosure, a light emitting device may contain four LEDs emitting at blue, green, amber and red wavelengths. The intensity of the blue LED may be regulated by a combination of an electronic driver and software. The light emitted from the LEDs may be mixed with optical components. Because the light sources are primary colors and for many, but not all, applications it is important that the “perceived color” be white, the fixture may contain a feature for mixing the light sources to produce white light. This can be achieved by using for example, textured, reflecting surfaces so the light has multiple reflections from surfaces, and/or transmission through diffusing material, or some combination thereof. To enhance the “whiteness” of the output light, or to create further variations of colors, a broad-spectrum white LED may be added to the above-mentioned colored light sources or to be mixed with them. This mixing may also enable the control of the white light output to the desired color temperature. For example, in some embodiments of the present disclosure, the light emitted by a device may be adjusted to a color temperature between about 2000K and about 6000K.

Although the examples provided above describe a light-emitting device in which the intensity of light emitted by a blue LED is variable, in some embodiments of the present disclosure, the light intensity of any one and/or all of the other LEDs contained in a multiple-LED device may also be controlled depending on the local needs. For example, a light-emitting LED may contain intensity-varying LEDs having at least one of blue light, green light, red light, amber light and/or other colors of visible light (for example, yellow, cyan or orange). Their intensities may be independently controlled by the use of separate drivers, drivers with multiple channels, and/or other mechanisms of independent control. Thus, embodiments other than the variable blue-emitting LED fall within the scope of the present disclosure.

In some embodiments, blue LED may be replaced with a phosphor-converted white LED to provide better color-rendering during early evening times. As used herein, a “color-rendering index” (CRI) is a measure of how accurately a series of selected color “swatches” are reproduced by the light-emitting devices described herein. In some embodiments of the present disclosure, a light-emitting device may provide light having a CRI that is greater than or equal to 70. In some embodiments of the present disclosure, a light-emitting device may provide light where 70≤CRI≤95. As with the operation of the blue LEDs, the intensity of the phosphor-converted white LEDs may be substantially decreased during early morning hours to reduce impact on wildlife. In some embodiments of the present disclosure, the light sources used may be lasers of one or more primary colors as stated earlier. This may be particularly important for high intensity applications and in applications where astronomical observations are important since optical filters may enable a larger portion of the visible spectrum to be accessed and filters may be more effective when tuned to a single wavelength rather than a range of wavelengths. Optical components used on lighting fixture may be designed to more optimally spatially shape the output light. In both the cases above (e.g. LEDs or lasers) a light fixture might be considered to be a sphere whose interior surface is a textured reflector to enable scattering of the light. In some embodiments of the present disclosure, about one quarter of the sphere may be missing to enable the exiting of the mixed light for illuminating the surrounding area. The exit might include one or more orifices either open or closed by a light scattering transmitting material such as textured glass or plastics.

In some embodiments, the FWHM wavelength ranges of each of the LEDs may be equal to or less than 30 nm, allowing the light from the LEDs to be blocked by a series of optical filters. The optical filters may not necessarily be placed on the light emitting device of the present disclosure (although placement of optical filers on the light emitting device is a possibility), but may instead be placed on external instruments that are sensitive to the light that is emitted from the device. Therefore, such a device may enable the objects surrounding the light source of this disclosure to be perceived in their correct color and appearance, while not interfering with astronomical observations, as an example. In animal husbandry, as well as horticulture, the relative intensities of color has been shown to affect productivity and growth rate. Thus, some of the embodiments described herein for light sources may be used to provide a tailored light source to enhance productivity. In the case of birds, for example, filters may be placed over birds eyes to alter specific wavelengths to enhance egg-laying, while not altering the appearance of the surroundings. Thus, in some embodiments of the present disclosure, at least one optical filter may be utilized with a light emitting device as described herein, with examples of optical filters including at least one of a colored glass filter, a bandpass filter, a laser line filter, an edge pass filter, a notch filter, and/or a dichroic color filter.

An example of tolerance levels of local wildlife or values set by a local regulation, are those as defined for sea turtles. This includes light-emitting devices that emit light having a wavelength of about 560 nm or longer; e.g. amber, orange, and/or red. These colors may be produced using at least one LED that emits at least one of amber, orange, and/or red. In some embodiments of the present disclosure, a light-emitting device that utilizes at least one LED may emit light (including light mixed by multiple LEDs) with a wavelength between 560 nm and 660 nm. In some embodiments of the present disclosure, a light-emitting device that utilizes at least one LED may emit light (including light mixed by multiple LEDs) with a wavelength distribution between the shortest wavelength and the longest wavelength of about 100 nm (i.e. longest wavelength minus the shortest wavelength equal about 100 nm). In some embodiments of the present disclosure, a light-emitting device may have a total power usage of between 1 watt and 35 watt, or between 15 watt and 20 watt. In some embodiments of the present disclosure, a light-emitting device that utilizes at least one LED may have a total intensity between 1 lumen/watt and 1000 lumen/watt, or between 10 lumen/watt and 300 lumen/watt. In some embodiments of the present disclosure, a light-emitting device that utilizes at least one LED may emit less than 20 lumens per square foot, of the space to be lit, or less than 10 lumens per square foot.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations, may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A device comprising:
a blue-emitting light emitting diode (LED) capable of emitting blue light at a first intensity; and
a non-blue-emitting LED capable of emitting light having a color other than blue, at a second intensity, wherein:
the first intensity is variable.

2. The device of claim 1, wherein the color other than blue comprises a light in the visible spectrum.

3. The device of claim 1, further comprising an element capable of varying the first intensity.

4. The device of claim 3, wherein the element is an electronic driver.

5. The device of claim 4, further comprising electronics configured to determine when the first intensity needs to be varied.

6. The device of claim 5, wherein the electronics comprises at least one of software or hardware.

7. The device of claim 6, wherein:
the hardware comprises a timer,
the first intensity has a low intensity value and a high intensity value determined by the software, and
the software and the timer are configured to communicate when the electronic driver adjusts a current to the blue-emitting LED to attain both the low intensity value and the high intensity value.

8. The device of claim 7, wherein the low intensity value is determined by a tolerance level of local wildlife.

9. The device of claim 7, wherein the high intensity value is determined by a value set by local rules and regulations.

10. The device of claim 1, wherein the device comprises two or more blue-emitting LEDs.

11. The device of claim 2, wherein the color other than blue comprises least one of red, amber, yellow, or green.

12. The device of claim 7, wherein the timer is a digital clock.

13. The device of claim 1, wherein the second intensity is variable.

14. The device of claim 1, further comprising a first optical component, wherein the first optical component varies at least one of the first intensity or a wavelength of the blue-emitting LED.

15. The device of claim 14, wherein the first optical component comprises an optical filter.

16. The device of claim 15, wherein the optical filter comprises at least one of a colored glass filter, a bandpass filter, a laser line filter, an edge pass filter, a notch filter, or a dichroic color filter.

17. The device of claim 1, further comprising a second optical component, wherein the second optical component mixes the blue light with the non-blue light.

18. The device of claim 15, wherein the second optical component comprises a textured reflector capable of scattering the blue light and the non-blue light.

19. The device of claim 15, wherein the blue light and the non-blue light mix to create light having a color temperature between about 2000K and about 6000K.

20. A method comprising:
mixing a blue light with a second light that is in the visible spectrum and not blue; and
varying an intensity of the blue light, wherein:
the mixing and the varying result in a light having a property comprising at least one of a color temperature, a color-rendering index, a wavelength distribution, or a total intensity, and
the property meets at least one of a tolerance level of local wildlife or a value set by a local regulation.
